(19) United States
(12) Patent Application Publication
(10) Pub. No.: US 2026/0168567 A1
(43) Pub. Date: Jun. 18, 2026

(54) HARMONIC REDUCER

(71) Applicant: ABB SCHWEIZ AG, Baden (CH)

(72) Inventors: Kai Yang, Shanghai (CN); Hui Yu, Shanghai (CN); Hao Gu, Shanghai (CN); Zhiyuan Liu, Shanghai (CN); Jiajun Ni, Shanghai (CN)

(21) Appl. No.: 19/465,953

(22) Filed: Jan. 30, 2026

Related U.S. Application Data
(63) Continuation of application No. PCT/CN2023/120736, filed on Sep. 22, 2023.

(51) Int. Cl. F16H 57/021; F16C 33/76; F16H 49/00

(52) U.S. Cl. CPC F16H 57/021; F16C 33/76; F16H 49/001; F16C 2229/00; F16C 2361/61

(57) ABSTRACT

A harmonic reducer includes a power shaft, a wave generator mounted on the power shaft, a circular spline including internal teeth, a flex spline including external teeth and configured to receive the wave generator to cause the external teeth to mesh with the internal teeth progressively as the wave generator rotates. The harmonic reducer further includes a bearing system configured to support the power shaft, and the bearing system includes at least one first bearing and a second bearing located at a first side of the wave generator.

### FIELD

Embodiments of the present disclosure generally relate to a harmonic reducer, in particular, a harmonic reducer for an industrial robot.

### BACKGROUND

Harmonic drives (also called harmonic reducer) are increasingly used due to their excellent torque increase performances. Harmonic drives are useful in increasing an output torque in gears used in various engineering fields, such as in milling, in manufacturing, and in machines that use robotic arms.

Harmonic reducers mainly consist of flex spline, circular spline, and a wave generator. The circular spline has internal teeth that mesh with external teeth on the flex spline. The wave generator is generally elliptical in shape and is arranged within the flex spline. Rotation of the wave generator causes the flex spline to mesh with the circular spline, typically, fixed, progressively at diametrically opposite points. The flex spline thus is driven to rotate so as to drive a load. A ratio of an input speed to an output speed may be high up to more than 320 with a single harmonic reducer, which are lighter, smaller, and more efficient than conventional high-ratio drives. However, the conventional harmonic reducers are not satisfactory in terms of lifetime and there is a need to further improve the harmonic reducers.

### SUMMARY

Example embodiments of the present disclosure provide a harmonic reducer with increased support stiffness, resulting in improved lifetime.

In a first aspect of the present disclosure, there is provided a harmonic reducer. The harmonic reducer comprises a power shaft, a wave generator mounted on the power shaft, a circular spline comprising internal teeth, a flex spline comprising external teeth and configured to receive the wave generator to cause the external teeth to mesh with the internal teeth progressively as the wave generator rotates, wherein the harmonic reducer further comprises a bearing system configured to support the power shaft, and the bearing system comprises at least one first bearing and a second bearing located at a first side of the wave generator. Provision of the at least two bearings at a single side, support stiffness can be effectively enhanced without increasing the bearing size, improving rotational stability of the input shaft and the distribution of forces in shaft bearing system.

In some embodiments, the first bearing may be axially spaced from the second bearing by a first gap on the first side. The distribution of forces can be further improved.

In some embodiments, the harmonic reducer may further comprise a first end flange configured to enclose a first end of an inner chamber in which the wave generator is located, wherein the first and second bearings are mounted to the power shaft by an interference fit, and the first bearing is located at a position that is further to the wave generator than the second bearing. The first end flange can facilitate sealing the inner chamber.

In some embodiments, the bearing system may further comprise a first gasket located between an outer ring of the first bearing and an outer ring of the second bearing to transfer an axial load from the outer ring of the second bearing to the outer ring of the first bearing. With this arrangement, the external axial loads can be further prevented from transmitting to the wave generator.

In some embodiments, the bearing system may further comprise a second gasket located between an inner ring of the first bearing and an inner ring of the second bearing, and a second inner diameter of the second gasket is below a first inner diameter of the first gasket. With the second gasket, the first and second bearings can be axially kept in position with reliability.

In some embodiments, a section of the power shaft between the first bearing and the second bearing may be of the same outer diameter.

In some embodiments, the first end flange may be fixed to the circular spline and comprises a step portion configured to axially support the first bearing.

In some embodiments, the first end flange may be fixed to a flange part of the flex spline, and the outer ring of the first bearing is axially supported by a pre-tensioned portion provided between the outer ring of the first bearing and an inner surface of the first end flange.

In some embodiments, the pre-tensioned portion may comprise a spring or a plurality of laminated plate.

In some embodiments, the bearing system may further comprise at least one third bearing located at a second side of the wave generator opposite to the first side.

In some embodiments, the harmonic reducer may further comprise a second end flange configured to enclose a second end of an inner chamber in which the wave generator is located, wherein the third bearing is mounted to the power shaft by an interference fit.

In some embodiments, the bearing system may further comprise a fourth bearing located at the second side of the wave generator and axially spaced from the third bearing by a second gap, and the third bearing is located at a position that is further to the wave generator than the fourth bearing and is axially supported by the second end flange. The support rigidity of the input shaft can be further improved.

In some embodiments, the bearing system may further comprise a third gasket located between an outer ring of the third bearing and an outer ring of the fourth bearing to transfer an axial load from the outer ring of the fourth bearing to the outer ring of the third bearing.

In some embodiments, the bearing system may further comprise a fourth gasket located between an inner ring of the third bearing and an inner ring of the fourth bearing; and a fourth inner diameter of the fourth gasket is below a third inner diameter of the third gasket.

In a second aspect of the present disclosure, there is provided an industrial robot. The industrial robot comprises: a harmonic reducer according to any of a first aspect of the present disclosure; a first arm connected to the circular spline; and a second arm connected to the flex spline.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a perspective view of a harmonic reducer according to one example embodiment of the present disclosure;

FIG. 2 is a sectional view of a harmonic reducer according to a first example embodiment of the present disclosure;

FIG. 3 is a perspective exploded view of the harmonic reducer shown in FIG. 2;

FIG. 4 is a sectional view of a harmonic reducer according to a second example embodiment of the present disclosure; and

FIG. 5 is a sectional view of a harmonic reducer according to a third example embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

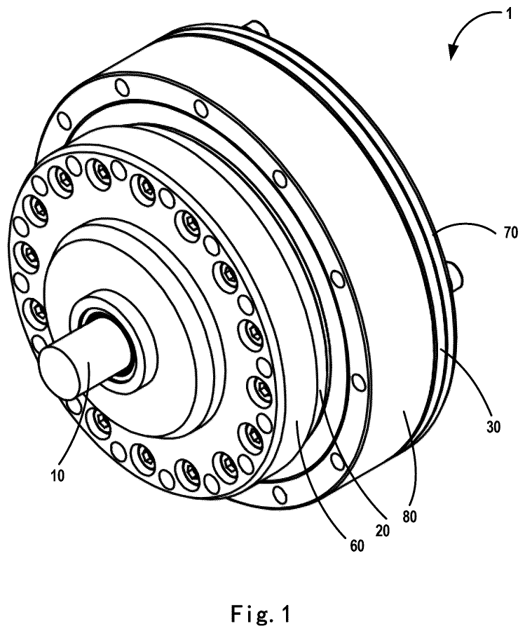

FIG. 1 shows a perspective view of a harmonic reducer 1 according to one example embodiment of the present disclosure. As shown in FIG. 1, the harmonic reducer 1 comprises a power shaft 10, a wave generator 40, a circular spline 20, and a flex spline 30. The power shaft 10 may be connected to a power source, such as a motor, a pulley drive, and the like. The wave generator 40 is mounted on the power shaft 10 and is configured to rotate as the power shaft 10 rotates. The circular spline 20 may include a cylindrical body on which internal teeth are provided. The flex spline 30 may comprise external teeth on the cylindrical body which are configured to mesh with the internal teeth on the circular spline 20. The flex spline 30 may include a thin wall which defines inner space and the wave generator 40 may be arranged within the inner space. The external teeth are provided on an outer surface of the thin wall. The wave generator 40 may be of an oval shape. As the wave generator 40 rotates, the external teeth on the flex spline 30 mesh with the internal teeth on circular spline 20 progressively on diametrically opposite points. In this way, the flex spline 30 is driven to rotate accordingly. The flex spline 30 may also be fixed to a load member. The load member in turn rotates.

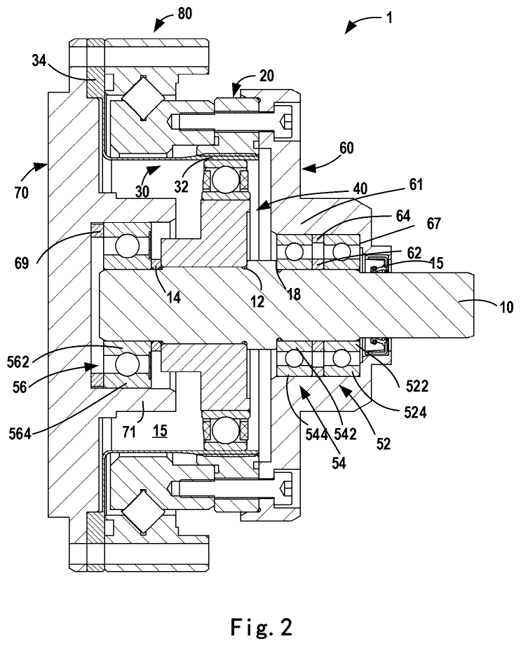

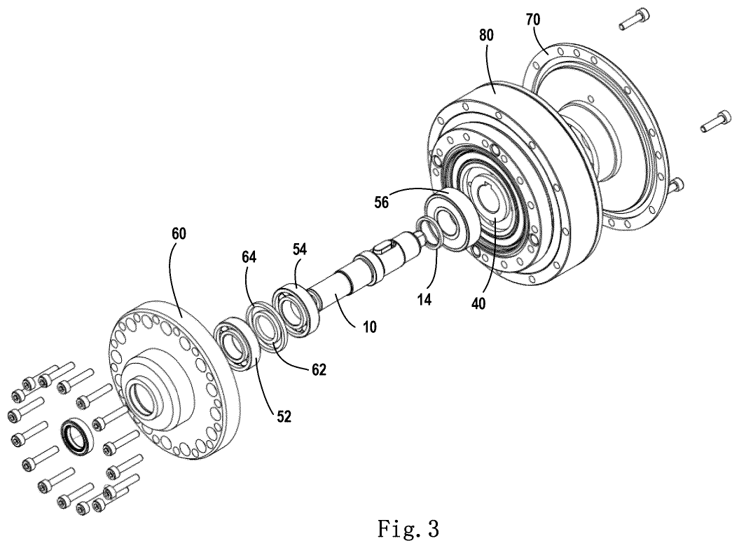

FIGS. 2 and 3 show a sectional view and a perspective exploded view of a harmonic reducer according to a first example embodiment of the present disclosure respectively. In the shown example, the flex spline 30 is in form of a top hat including a cylinder part 32 and a flange part 34. The external teeth are provided a cylinder part of the flex spline 30. The flange part 34 may be connected to the load member. It is to be understood that the shown example is merely illustrative and the flex spline 30 may be of other proper shapes.

As shown in FIGS. 2 and 3, the harmonic reducer 1 may further comprise a first end flange 60. The first end flange 60 is configured to enclose a first end of an inner chamber 15 in which the wave generator 40 is located. The first end flange 60 may be fixed to the circular spline 20 via fasteners (for example, screws). The harmonic reducer 1 may further comprise a second end flange 70 which may be a part of the load member. The second end flange 70 is configured to enclose a second opposite end of the inner chamber 15. The second end flange 70 may be fixed to the flex spline 30, for example, at the flange part 34, via fasteners (for example, screws). Within the inner chamber 15, lubricating oil may be arranged.

As shown in FIGS. 2 and 3, the harmonic reducer 1 may further comprise a support bearing 80. An outer ring of the support bearing 80 may be fixed to the flange part 34 and the second end flange 70 via fasteners. An inner ring of the support bearing 80 may be fixed to the circular spline 20 and the first end flange 60 via fasteners. The support bearing is configured to bear output axial/radial load and bending moment.

As shown in FIGS. 2 and 3, the harmonic reducer 1 further comprises a bearing system configured to support the power shaft 10. The bearing system comprises at least one first bearing 52 and a second bearing 54 located at one side of the wave generator 40. In the shown example, the first bearing 52 and the second bearing 54 are located at a power input side, i.e., a side at which the first end flange 60 is located in the shown example. As shown, the first bearing 52 and the second bearing 54 are of a single-row deep groove ball bearing. It is to be understood that the first bearing 52 and the second bearing 54 may use other type of bearings, such as double-row angular contact ball bearings. The first bearing 52 and the second bearing 54 may be of the same type, or of different type.

During operation of the harmonic reducer 1, various undesired loads (for example, external axial/radial loads) caused by various factors, such as mounting tolerances between the components, thermal expansion of the components, external turbulences from the surroundings, and the like, may be applied to the power shaft 10, which is in turn transmitted to the wave generator 32. A section of the flex spline 30 at which the external teeth are provided is typically of a thin wall which is very sensitive to outer turbulence loads. Lifetime of the flex spline 30 (and in turn the harmonic reducer 1) is greatly affected by its support rigidity. When the undesired loads from the power shaft 10 are transmitted to the wave generator 32, the wave generator 32 tends to fail ahead of its design life. Stiffness of the bearing system is critical to reliability and the lifetime of the harmonic reducer. When the support rigidity is insufficient, the wave generator 32 will be subjected to additional external forces/vibration, which may seriously reduce its life.

Increasing the diameter of the power shaft 10 is effective in increasing the rigidity of the bearing system. But this measure has a number of disadvantages. Increasing the diameter of the power shaft 10 results in a larger size of the harmonic reducer, which is not desired in many applications. Also, a bigger diameter of the power shaft 10 means the higher manufacturing costs. In addition, risk of oil leakage from the inner chamber is increased. According to the present disclosure, a novel system in which at least two bearings 52, 54 are provided at one side of the wave generator 40 is proposed to increase rigidity of the bearing system. At least two bearings 52, 54 are provided at one side of the wave generator 40. Provision of the two bearings 52, 54 at one side of the wave generator 40 can improve the stiffness of the bearing system. Thus, undesired loads can be prevented transmitting from the power shaft 10 to the wave generator 32.

In some embodiments, as shown in FIGS. 2 and 3, on the first side (i.e., the right side in the drawing, and also corresponding to the power input side), two bearings 52, 54 are provided and one bearing 56 is provided at the power input side (i.e., the left side in the drawing, and also corresponding to the load side). The bearing 54 may be firstly mounted to the power shaft 10 by an interference fit. An axial positioning means, for example, an axial step 18 may be provided on the power shaft 10 to axially position the bearing 54. An outer ring of the bearing 54 may be separate from the inner surface of a housing 61 of the end flange 60 by a clearance. After the bearing 54 being mounted onto the power shaft 10, another bearing 52 may be mounted to the power shaft 10 likewise, for example, by an interference fit. Likewise, an outer ring 524 of the bearing 52 may be separate from the inner surface of the housing 61 by a clearance. The bearing 52 may be located at a position that is further to the wave generator 40 than the bearing 52. In some embodiments, the bearing 54 may be immediately adjacent to the bearing 52. In some embodiments, the bearing 52 may be axially spaced from the bearing 54 by a gap on the first side.

In some embodiments, as shown in FIGS. 2 and 3, the bearing system may further comprise an outer gasket 64 located between an outer ring 524 of the bearing 52 and an outer ring 544 of the bearing 54. One end of the outer gasket 64 abuts against an axial end surface of the outer ring 544 of the bearing 54. An opposite end of the outer gasket 64 abuts against an axial end surface of the outer ring 524 of the bearing 52. The bearing 52 may also be axially positioned by the housing 61 of the end flange 60, for example, by a step 67 provided at an inner surface of the housing 61 of the end flange 60. Thus, during rotation of the power shaft 10, undesired loads, such as radial loads, can be transmitted among the bearings 52, 54. In particular, an axial load from the outer ring 544 of the bearing 54 may be transferred to the outer ring 524 of the bearing 52, and further to the end flange 60. Since the single-side double bearing support stiffness is the sum of the two bearings, the support stiffness can be effectively enhanced without increasing the bearing size, thus improving the rotational stability of the input shaft and the distribution of forces in shaft bearing system.

In some embodiments, as shown in FIGS. 2 and 3, the bearing system may further comprise an inner gasket 62 located between an inner ring 522 of the bearing 52 and an inner ring 542 of the bearing 54. An inner diameter of the gasket 62 is smaller than an inner diameter of the outer gasket 64. One end of the inner gasket 62 abuts against an axial end surface of the inner ring 542 of the bearing 54. An opposite end of the inner gasket 62 abuts against an axial end surface of the inner ring 522 of the bearing 52. In the shown example, the inner gasket 62 is provided for axially restricting movement the inner rings of the bearing 52, 54. It is to be understood that the shown example is merely illustrative and other proper means may be used to restrict relative moment between the inner ring 524 of the bearing 52 and the inner ring 542 of the bearing 54.

In some embodiments, as shown in FIGS. 2 and 3, one bearing 56 is provided on the load side. On the left side of the wave generator 40, a position ring 14 may be arranged around the power shaft 10. The bearing 56 may be mounted to the power shaft 10 by an interference fit. An outer ring 564 of the bearing 56 may be separate from the inner surface of the end flange 70 by a clearance. An inner ring 562 of the bearing 56 may abut against the position ring 14. The outer ring 562 of the bearing 56 may be axially supported by a pre-tensioned portion 69. The pre-tensioned portion 69 is provided between the outer ring 562 of the bearing 52 and an inner surface of a circumferential extension 71 of the end flange 70. The pre-tensioned portion 69 may be pre-tensioned when the power shaft 10 as well as the assembled bearings 52, 54, 56 is assembled into the inner chamber 15. The pre-tensioned portion 69 may be of various forms. In some embodiments, the pre-tensioned portion 69 may be made of springs. In some embodiments, the pre-tensioned portion 69 may be made of laminated plates. With this arrangement, both sides of the and wave generator 40, i.e., a side adjacent to the end flange 70 and an opposite side adjacent to the end flange 60, can be reliably supported by the bearings 52, 54, 56.

In the shown example, the power shaft 10 is of substantially the same outer diameter at the positions at which the bearings 52, 54, 56 are provided. It is to be understood that the shown example is merely illustrative and the outer diameter of the power shaft 10 may vary according to positions of the bearings. In the shown example, there are two bearings 52, 54 are provided at the side adjacent to the end flange 60 (i.e., the power input side). It is to be understood that more than two bearings 52, 54, for example, 3, 4 or more bearings may be provided at the power input side.

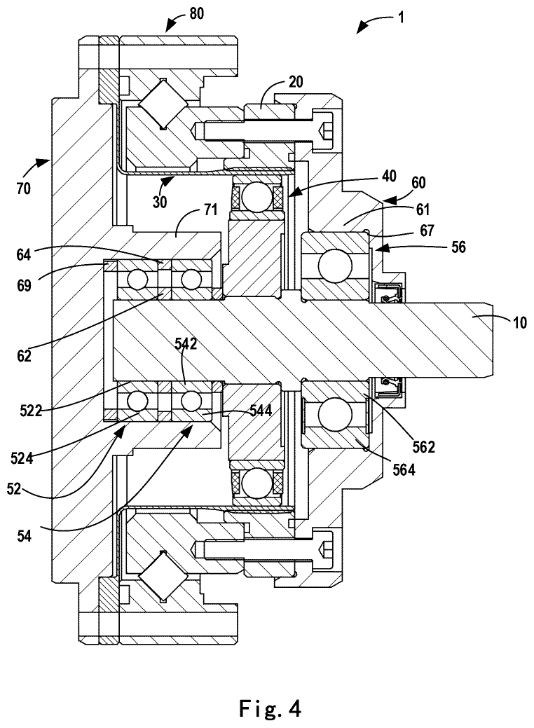

FIG. 4 is a sectional view of a harmonic reducer 1 according to a second example embodiment of the present disclosure. The harmonic reducer 1 shown in FIG. 4 is substantially the same as that shown in FIG. 2. The difference is that in FIG. 4 there are two bearings 52, 54 provided at the load side, and one bearing 56 is provided at the power input side. The configuration of these bearings in this embodiment are substantially the same as those as set forth with respect to FIG. 2 and their detailed description is thus omitted. As shown in FIG. 4, the bearings 52, 54 may be of the same size while the size of the bearing 56 may be different from those of the bearings 52, 54. It is to be understood that the shown example is merely illustrative and the bearings 52, 54, 56 may be any other proper types.

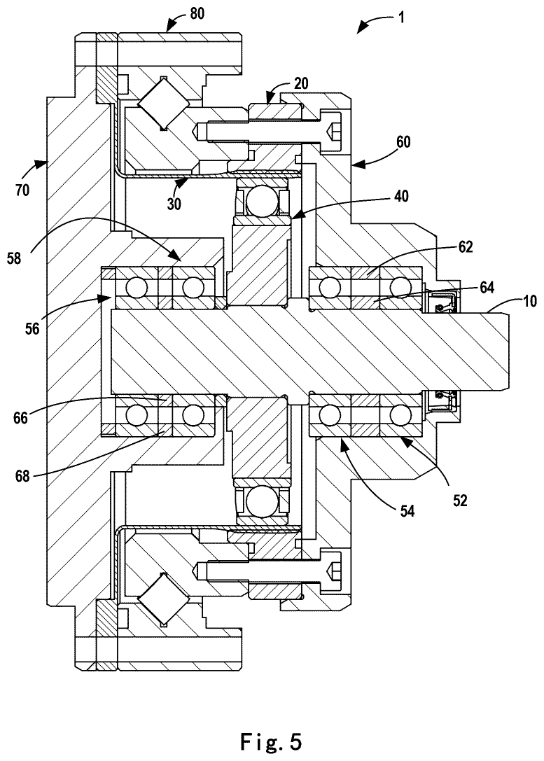

FIG. 5 is a sectional view of a harmonic reducer 1 according to a third example embodiment of the present disclosure. The harmonic reducer 1 shown in FIG. 5 is substantially the same as that shown in FIGS. 2 and 4. The difference is that in FIG. 5 there are two bearings 52, 54 provided at the power input side, and two bearings 56, 58 are provided at the load side. The configuration of bearings 52, 54 at the power input side in this embodiment are substantially the same as the bearings 52, 54 as set forth with respect to FIG. 2. Their detailed description is omitted.

The two bearings 56, 58 at the load side are analogously arranged. As shown in FIG. 5, the bearing system may further comprise an outer gasket 68 located between an outer ring of the bearing 56 and an outer ring of the bearing 58. One end of the outer gasket 68 abuts against an axial end surface of the outer ring of the bearing 56. An opposite end of the outer gasket 68 abuts against an axial end surface of the outer ring of the bearing 58. The bearing 56 may also be axially positioned by the circumferential extension 71 of the end flange 70. Thus, during rotation of the power shaft 10, undesired loads, such as radial loads, can be transmitted among the bearings 56, 58 at the load side. In particular, an axial load from the outer ring of the bearing 58 may be transferred to the outer ring of the bearing 56, and further to the end flange 70.

In some embodiments, as shown in FIG. 5, the bearing system may further comprise an inner gasket 66 located between an inner ring of the bearing 56 and an inner ring of the bearing 58. An inner diameter of the gasket 66 is smaller than an inner diameter of the outer gasket 68. One end of the inner gasket 66 abuts against an axial end surface of the inner ring of the bearing 56. An opposite end of the inner gasket 66 abuts against an axial end surface of the inner ring of the bearing 58. In the shown example, the inner gasket 62 is provided for axially restricting movement the inner rings of the bearings 56, 58. It is to be understood that the shown example is merely illustrative and other proper means may be used to restrict relative moment between the inner ring of the bearing 56 and the inner ring of the bearing 58.

According to the present disclosure, the harmonic reducer 1 may be used in various engineering fields. The circular spline 20 of the harmonic reducer 1 may be fixed to a first member. For example, the first member may be fixed to the end flange 60 of the circular spline 20 (referring to FIGS. 1 and 2). The first member may be a fixed member or a movable member. The drive, such as the motor, the pulley drive and the like, may be mounted on the first member. The flex spline 30 of the harmonic reducer 1 may be fixed to a second member. For example, the second member may be fixed to the end flange 70 of the flex spline 30 (referring to FIGS. 1 and 2). In this way, when the drive operates, the second member can be actuated by the harmonic reducer 1. In some embodiments, the harmonic reducer 1 may be used in an industrial robot. In particular, the harmonic reducer 1 may be used as a joint. In this case, the first member may be a robotic arm of the industrial robot. The second member may be an adjacent robotic arm of the industrial robot.

According to the present disclosure, by provision of at least two bearing at the power input side and/or the load side, the support rigidity of the bearing system can be improved without substantially amending the structures of the harmonic reducer. Undesired external loads, in particular, radial and/or axial loads, can be prevented from transferring from the power shaft to the wave generator, which results in improved service lifetime of the harmonic reducer.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A harmonic reducer, comprising:
a power shaft;
a wave generator mounted on the power shaft;
a circular spline comprising internal teeth; and
a flex spline comprising external teeth and configured to receive the wave generator to cause the external teeth to mesh with the internal teeth progressively as the wave generator rotates,
wherein the harmonic reducer further comprises a bearing system configured to support the power shaft, and the bearing system comprises at least one first bearing and a second bearing located at a first side of the wave generator.

2. The harmonic reducer of claim 1, wherein the first bearing is axially spaced from the second bearing by a first gap on the first side.

3. The harmonic reducer of claim 2, further comprising a first end flange configured to enclose a first end of an inner chamber in which the wave generator is located, wherein the first and second bearings are mounted to the power shaft by an interference fit, and the first bearing is located at a position that is further to the wave generator than the second bearing,

4. The harmonic reducer of claim 3, wherein the bearing system further comprises a first gasket located between an outer ring of the first bearing and an outer ring of the second bearing to transfer an axial load from the outer ring of the second bearing to the outer ring of the first bearing.

5. The harmonic reducer of claim 3, wherein the bearing system further comprises a second gasket located between an inner ring of the first bearing and an inner ring of the second bearing, and
a second inner diameter of the second gasket is below a first inner diameter of the first gasket.

6. The harmonic reducer of claim 2, wherein a section of the power shaft between the first bearing and the second bearing is of the same outer diameter.

7. The harmonic reducer of claim 3, wherein the first end flange is fixed to the circular spline and comprises a step portion configured to axially support the first bearing

8. The harmonic reducer of claim 4, wherein the first end flange is fixed to a flange part of the flex spline and
the outer ring of the first bearing is axially supported by a pre-tensioned portion provided between the outer ring of the first bearing and an inner surface of the first end flange.

9. The harmonic reducer of claim 8, wherein the pre-tensioned portion comprises a spring or a plurality of laminated plate.

10. The harmonic reducer of claim 1, wherein the bearing system further comprises at least one third bearing located at a second side of the wave generator opposite to the first side.

11. The harmonic reducer of claim 10, further comprising a second end flange configured to enclose a second end of an inner chamber in which the wave generator is located, wherein the third bearing is mounted to the power shaft by an interference fit.

12. The harmonic reducer of claim 11, wherein the bearing system further comprises a fourth bearing located at the second side of the wave generator and axially spaced from the third bearing by a second gap, and
the third bearing is located at a position that is further to the wave generator than the fourth bearing and is axially supported by the second end flange.

13. The harmonic reducer of claim 12, wherein the bearing system further comprises a third gasket located between an outer ring of the third bearing and an outer ring of the fourth bearing to transfer an axial load from the outer ring of the fourth bearing to the outer ring of the third bearing.

14. The harmonic reducer of claim 12, wherein the bearing system further comprises a fourth gasket located between an inner ring of the third bearing and an inner ring of the fourth bearing; and
a fourth inner diameter of the fourth gasket is below a third inner diameter of the third gasket.

15. An industrial robot, comprising:
the harmonic reducer according to claim 1;
a first arm connected to the circular spline; and
a second arm connected to the flex spline.
